(19) United States
(12) Patent Application Publication
(10) Pub. No.: US 2011/0082810 A1
(43) Pub. Date: Apr. 7, 2011

(54) Human-readable baggage and cargo routing identification system

(75) Inventors: Frankie Holtz-Davis, North Las Vegas, NV (US); Derrick Holtz, Mira Loma, CA (US)

(73) Assignee: Walt-Task, LLC

(21) Appl. No.: 12/008,615

(22) Filed: Jan. 10, 2008

(51) Int. Cl. G06Q 10/00; G06Q 90/00; G09F 3/02

(52) U.S. Cl. 705/330; 705/500; 40/6

(57) ABSTRACT

The apparatus for facilitating the movement of a luggage item through transit comprising a non-metallic substrate; an emblem disposed on the substrate, said emblem indicating a geographic location; wherein a user may see the destination of the luggage item and move the luggage item in transit accordingly.

### FIELD OF DISLOSURE

The present invention relates generally to travel-related apparatus, systems and methods for facilitating the routing of baggage and cargo through commercial carrier systems. More particularly, the present invention relates to a new apparatus, system and method for providing human-readable baggage and cargo routing. The systems and methods allow certain apparatus to be utilized for improving the transportation of baggage and other packages and for reducing the number of lost items in transit by airlines and other carriers by deploying a graphical, imprinted identifier as a different, human-readable means of indicating the final destination of an individual item in transit.

### BACKGROUND

It is estimated that the travel industry loses about 20 million pieces per year worldwide and this number is expected to continue to increase. Recent estimates of lost baggage are reported at over 366,000 pieces of luggage per month in the United States alone. These losses have increased in spite of technological advances in the travel industry. Although technological advances such as bar coding provide for more reliable baggage handling, there is a still a need for a practical human-readable media to facilitate human interaction with regards to items in transit. As such, what is required is an easy-to-use system for assuring that airport and other transportation workers move any item in transit quickly to its appropriate destination, and that workers are able to quickly and easily identify and rectify any misrouting of items in transit using simple graphical cues.

### SUMMARY OF THE INVENTION

Disclosed herein is a apparatus for facilitating the movement of an item in transit comprising a non-metallic substrate, an emblem disposed on the substrate, the emblem indicating a geographic location, a method for affixing the emblem on the non-metallic substrate, and a system for producing the emblem; wherein a user may visually interpret the destination of the item in transit by use of the emblem, and move the item in transit accordingly.

The present invention discloses a method for facilitating the movement of an item in transit by facilitating the ability to visually discern, at a glance, whether the particular item in transit has been incorrectly routed. This is accomplished by associating the item in transit with a human-readable emblem that is a graphical representation of the item's final destination. The emblem can be associated with other user-selected indicia such as barcodes, city codes and other destination-related information. The emblem and indicia are disposed to a substrate to create an imprinted identifier, which is to be fastened or affixed to an individual item in transit. The emblem and any associated indicia are associated with a physical route that the item in transit will take. Along the route, baggage and cargo handlers can visually inspect the imprinted identifier attached to an individual item in transit to determine whether the present route correctly associates with the emblem disposed on the imprinted identifier. This method of visually inspecting baggage and cargo tags for the correctness of the present route allows handlers to remove an item in transit from the present route where imprinted identifiers show an emblem that has been determined to be incorrectly associated with the present route. This allows carriers an opportunity for trained handlers to rectify routing problems through the use of said emblems, before a misrouted item reaches an incorrect terminal destination. The visual identification of emblems is facilitated through the use of printed references posted in facilities routing items in transit.

The imprinted identifiers disclosed herein can have many embodiments, including but not limited to a pre-manufactured multi-use identifier wherein the substrate is substantially the same shape of the emblem; a pre-manufactured multi-use identifier wherein the substrate provides usable space outside of the emblem; a flexible or semi-rigid material such as paper, plastic or cardboard providing a substrate for a custom-printed imprinted identifier; an adhesive-backed substrate wherein the substrate is substantially the same shape of the emblem; and an adhesive-backed substrate wherein the substrate provides usable space outside of the emblem. Each identifier has an attachment component, such as a pre-cut slit for fastener or an adhesive material.

The proper emblem and indicia for each individual item in transit is selected visually as for pre-manufactured multi-use tags or through the use of a computer system, well known in the art, where the proper emblem is manually identified and selected by a human, or through the use of entity relationships in a relational database or other electronically stored destination-to-image relationship. Likewise, emblems and indicia selected by any means are disposed onto a substrate through the use of printing devices well known in the art onto the substrate chosen by the carrier.

In one embodiment, a method for facilitating the movement of an item in transit by facilitating the ability to visually discern, at a glance, whether the item in transit has been incorrectly routed, comprises associating the item in transit with a human-readable emblem that is a graphical representation of the item's final destination and any user-selected indicia; affixing the emblem and indicia to a substrate to create an imprinted identifier; associating the emblem with a physical route; visually inspecting the imprinted identifier attached to the item in transit to determine whether the present route correctly associates with the emblem disposed on the imprinted identifier; removing an item in transit from the present route with imprinted identifiers showing an emblem that has been determined to be incorrectly associated with the present route; and re-associating the item in transit with imprinted identifier to the correct route and correlating route identifiers wherein the user has been trained to visually read and understand the destination of the item in transit by use of the emblems, and moves the item in transit accordingly.

In certain aspects, the method for facilitating the movement of an item in transit by facilitating the ability to visually discern, at a glance, whether said item in transit has been incorrectly routed, by identifying a routing status, further includes a modified routing status wherein the final destination of the item in transit is associated with the correlating emblem.

In other aspects, the method for facilitating the movement of an item in transit by facilitating the ability to visually discern, at a glance, whether said item in transit has been incorrectly routed, by identifying a routing status, further comprises a modified routing status wherein the correct emblem is disposed onto a substrate to create the imprinted identifier.

In another embodiment, the method for facilitating the movement of an item in transit by facilitating the ability to visually discern, at a glance, whether said item in transit has been incorrectly routed, by identifying a routing status, further comprises a modified routing status wherein said imprinted identifier to affix to said item in transit is selected from a group consisting of a pre-manufactured multi-use identifier wherein the substrate is substantially the same shape of the emblem; a pre-manufactured multi-use identifier wherein the substrate provides usable space outside of the emblem; a flexible or semi-rigid material such as paper, plastic or cardboard providing a substrate for a custom-printed imprinted identifier; an adhesive-backed substrate wherein the substrate is substantially the same shape of the emblem; and an adhesive-backed substrate wherein the substrate provides usable space outside of the emblem.

In other aspects, the method for facilitating the movement of an item in transit by facilitating the ability to visually discern, at a glance, whether the item in transit has been incorrectly routed, by identifying a routing status, further comprises a modified routing status wherein the imprinted identifier is affixed to said item in transit.

In another embodiment, the method for facilitating the movement of an item in transit by facilitating the ability to visually discern, at a glance, whether the item in transit has been incorrectly routed, by identifying a routing status, further comprises a modified routing status wherein the user attaches the imprinted identifier by one of the methods selected from a group consisting of adhesives, an attached fastener and a space provided specifically to use existing fasteners.

In certain aspects, the method for facilitating the movement of an item in transit by facilitating the ability to visually discern, at a glance, whether said item in transit has been incorrectly routed, by identifying a routing status, further comprises a modified routing status wherein the visual identification of emblems is facilitated through the use of printed references posted in facilities routing items in transit.

In other aspects, the method for facilitating the movement of an item in transit by facilitating the ability to visually discern, at a glance, whether said item in transit has been incorrectly routed, by identifying a routing status, further comprises a modified routing status wherein a misrouted item is identified and re-routed correctly.

In another embodiment, an apparatus for facilitating the movement of an item in transit comprises a non-metallic substrate; an emblem disposed on the substrate, said emblem being a human-readable graphical representation of the final destination of said item in transit; and an attachment component wherein the user has been trained to visually read and understand the destination of the item in transit by use of said emblems and moves the item in transit accordingly.

In certain aspects, an apparatus for facilitating the movement of an item in transit comprises a non-metallic substrate; an emblem disposed on the substrate, said emblem being a human-readable graphical representation of the final destination of said item in transit; and an attachment component wherein the user has been trained to visually read and understand the destination of the item in transit by use of said emblems and moves the item in transit accordingly and wherein the physical embodiment of said imprinted identifier is selected from a group consisting of a pre-manufactured multi-use identifier wherein the substrate is substantially the same shape of the emblem; a pre-manufactured multi-use identifier wherein the substrate provides usable space outside of the emblem; a flexible or semi-rigid material such as paper, plastic or cardboard providing a substrate for a custom-printed imprinted identifier; an adhesive-backed substrate wherein the substrate is substantially the same shape of the emblem; and an adhesive-backed substrate wherein the substrate provides usable space outside of the emblem.

In other aspects of the embodiment, an apparatus for facilitating the movement of an item in transit comprises a non-metallic substrate; an emblem disposed on the substrate, said emblem being a human-readable graphical representation of the final destination of said item in transit; and an attachment component wherein the user has been trained to visually read and understand the destination of the item in transit by use of said emblems and moves the item in transit accordingly wherein the display area of the imprinted identifier includes supplemental information selected from a group containing barcodes, additional graphical elements, textual information and no additional information.

In other aspects of the embodiment, an apparatus for facilitating the movement of an item in transit comprises a non-metallic substrate; an emblem disposed on the substrate, the emblem being a human-readable graphical representation of the final destination of the item in transit; and an attachment component wherein the user has been trained to visually read and understand the destination of the item in transit by use of the emblems and moves the item in transit accordingly wherein the imprinted identifier is physically attached to an item in transit by a means selected from a group consisting of adhesives, an attached fastener and a space provided specifically to use separate fastening devices.

In other aspects of the embodiment, an apparatus for facilitating the movement of an item in transit comprises a non-metallic substrate; an emblem disposed on the substrate, said emblem being a human-readable graphical representation of the final destination of said item in transit; and an attachment component wherein the user has been trained to visually read and understand the destination of the item in transit by use of said emblems and moves the item in transit accordingly wherein the imprinted identifier is physically attached to an item in transit by a means selected from a group consisting of adhesives, an attached fastener and a space provided specifically to use separate fastening devices.

In other aspects of the embodiment, an apparatus for facilitating the movement of an item in transit comprises a non-metallic substrate; an emblem disposed on the substrate, said emblem being a human-readable graphical representation of the final destination of said item in transit; and an attachment component wherein the user has been trained to visually read and understand the destination of the item in transit by use of said emblems and moves the item in transit accordingly wherein the substrate is a carrier-printed baggage tag having a bar code, and the emblem and any associated indicia are printed on the baggage tag.

In one embodiment, a method for facilitating the movement of an item in transit by facilitating the ability to visually discern, at a glance, whether the item in transit has been incorrectly routed, comprises associating the item in transit with a human-readable emblem that is a graphical representation of the item's final destination and any user-selected indicia; affixing the emblem and indicia to a substrate to create an imprinted identifier; associating the emblem with a physical route; visually inspecting the imprinted identifier attached to the item in transit to determine whether the present route correctly associates with the emblem disposed on the imprinted identifier; removing an item in transit from the present route with imprinted identifiers showing an emblem that has been determined to be incorrectly associated with the present route; and re-associating the item in transit with imprinted identifier to the correct route and correlating route identifiers wherein the user has been trained to visually read and understand the destination of the item in transit by use of the emblems on the imprinted identifier that are affixed to the item in transit, and moves the item in transit accordingly.

In certain aspects, the imprinted identifier can be a physical printed label comprised of one or more pre-manufactured multi-use identifiers wherein the substrate is substantially the same shape of the emblem, pre-manufactured multi-use identifiers wherein the substrate provides usable space outside of the emblem; a flexible or semi-rigid material such as paper, plastic or cardboard providing a substrate for a custom-printed imprinted identifiers or an adhesive-backed substrate wherein the substrate is substantially the same shape of the emblem and an adhesive-backed substrate wherein the substrate provides usable space outside of the emblem.

In another embodiment, a system for disposing an emblem and associated indicia onto a given substrate comprises one or more indicia associated with one or more final destinations.

In another embodiment, the proper emblem and indicia are associated with the final destination on a carrier-printed baggage tag by one of a means selected from the group consisting of a user selection and a relational database entity relationship.

In certain aspects, the proper emblem and indicia are printed on the carrier-printed baggage claim tag.

In other aspects, the proper emblem and indicia are associated with the final destination on a carrier-printed cargo manifest by one of a means selected from the group consisting of a user selection and a relational database entity relationship.

In another embodiment, an emblem and associated indicia are physically disposed onto a substrate.

In another embodiment, the proper emblem and indicia are associated with the final destination on a carrier-printed cargo manifest by an automated means of information management.

In one embodiment, an apparatus for facilitating the movement of an item in transit can be comprised of a non-metallic substrate, an emblem disposed on the substrate, that emblem being a human-readable graphical representation of the final destination of the item in transit and an attachment component to allow a user to view, read and understand the destination of the item in transit by use of said emblems and allowing the user to move the item in transit accordingly.

In another embodiment, the system comprises a computer-readable memory medium storing a computer-executable program comprising code which when executed implements a method comprising the steps of: accepting as input the final destination of said item in transit; associating the input to an emblem; selecting appropriate additional indicia; returning data comprising the appropriate emblem and indicia; causing said returned data to be interpreted by a program for purposes selected from the group including displaying said emblem and indicia on a digital display screen, printing said emblem and indicia on a substrate and both printing and displaying said emblem and indicia wherein the computer-readable memory medium is contained in a computer system comprising: a microprocessor and supporting RAM and other electrical components and circuits, a STDIN (standard input) device such as a keyboard, a STDOUT (standard output) device such as a digital display, a medium capable of storing program code and data, a printing device, and a connecting means to a power source.

In one embodiment, a computer system can provide a method of human-readable item routing identification, the system including a memory containing predetermined instructions and one or more data structures, a processing unit operatively coupled to the memory and capable of executing the predetermined instructions, an output device operatively coupled to the memory and the processing unit, wherein the processing unit executes the predetermined instructions to perform the following steps: dispose an emblem and associated indicia onto a given substrate, associate one or more indicia with one or more final destinations, accept as input the final destination of said item in transit, associate the input to an emblem, select appropriate additional indicia; and return data comprising user selected emblem and indicia to a user for printing or modification.

In another embodiment, a system can provide a method of routing identification for an item in transit, the system including a processor operable to execute instructions and a data storage, computer-readable medium for storing the instructions that, when executed by the processor, cause the processor to perform the method comprising: associating the item in transit with a human-readable emblem that is a graphical representation of the item's final destination and any user-selected indicia, affixing said emblem and indicia to a substrate to create an imprinted identifier, associating said emblem with a physical route, visually inspecting said imprinted identifier attached to the item in transit to determine whether the present route correctly associates with the emblem disposed on the imprinted identifier, removing an item in transit from the present route with imprinted identifiers showing an emblem that has been determined to be incorrectly associated with the present route, re-associating the item in transit with imprinted identifier to the correct route and correlating route identifiers wherein said emblems allow a user to more accurately identify the destination of the item in transit, and move the item in transit accordingly.

In one embodiment, a computer readable medium for providing instructions for executing methods of routing identification for an item in transit can be comprised of: program code for disposing an emblem and associated indicia onto a given substrate, program code for associating one or more indicia with one or more final destinations, program code for accepting as input the final destination of said item in transit, program code for associating the input to an emblem, program code for selecting appropriate additional indicia, and program code for returning data comprising user selected emblem and indicia to a user for printing or modification.

In another embodiment, a computer readable medium for providing instructions for executing methods of routing identification for an item in transit can be comprised of: program code for disposing an emblem and associated indicia onto a given substrate, program code for associating one or more indicia with one or more final destinations, program code for accepting as input the final destination of said item in transit, program code for associating the input to an emblem, program code for selecting appropriate additional indicia, program code for returning data comprising user selected emblem and indicia to a user for printing or modification, program code for associating said item in transit with a human-readable emblem that is a graphical representation of said item's final destination and any user-selected indicia, program code for affixing said emblem and indicia to a substrate to create an imprinted identifier, program code for associating said emblem with a physical route, program code for visually inspecting said imprinted identifier attached to said item in transit to determine whether the present route correctly associates with said emblem disposed on said imprinted identifier, program code for removing an item in transit from the present route with imprinted identifiers showing an emblem that has been determined to be incorrectly associated with the present route and program code for re-associating said item in transit with imprinted identifier to the correct route and correlating route identifiers wherein said emblems allow a user to more accurately identify the destination of the item in transit, and move the item in transit accordingly.

The construction and method of operation of the invention, together with additional objectives and advantages thereof, will be best understood from the following description of specific embodiments when read in connection with the accompanying drawings.

The design and construction of computer systems, including printing facilities and relational databases used to associate one datum to another are not discussed in detail, as these systems are well-known to those in the art.

### BRIEF DESCRIPTION OF THE DRAWINGS

FIG. 1 illustrates a first embodiment according to the current disclosure.

FIG. 2 shows another embodiment according to the current disclosure wherein the substrate is shaped like a geographic region.

FIG. 3 illustrates an embodiment according to the current disclosure wherein a geographic location is imprinted on an airline-imprinted baggage tag.

FIG. 4 illustrates yet another embodiment according to the current disclosure wherein the substrate is a decal.

FIG. 5 illustrates yet another embodiment according to the current disclosure with an emblem on a decal.

FIG. 6 illustrates yet another embodiment according to the current disclosure wherein the substrate is a decal.

FIG. 7 illustrates yet another embodiment according to the current disclosure with an emblem on a decal.

FIG. 8 shows a block diagram illustrating components of an exemplary operating environment.

FIG. 9 illustrates an exemplary computer system, in which various embodiments of the present invention may be implemented.

### DETAILED DESCRIPTION

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

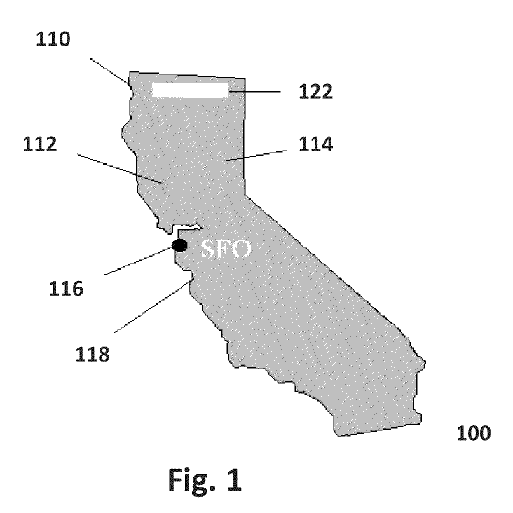

FIG. 1 illustrates a first embodiment 100 according to the current disclosure, wherein the substrate is shaped like a geographic region. In the figure, an emblem- and indicia-imprinted substrate (hereafter referred to as “the imprinted identifier”) comprises a substrate 110 created from a non-metallic flexible or semi-rigid material such as paper, plastic or cardboard; a display area 112; and an emblem 114 disposed thereon, formed to represent a geographical area such as a state or a country. The emblem may be any means imprinted or impressed into the display area 112 for providing a visually recognizable image. The emblem 114 is designed to illustrate the location of the terminal point of the item in transit upon which the imprinted identifier is attached. In the example shown the emblem 114 particularly indicates the geographic location of San Francisco International airport 116. The substrate 110 is shaped for providing an easily recognizable geographical area such that viewing the imprinted identifier indicates to a user the terminal point of an item in transit attached thereto. The substrate 110 provides a fastening means 122 for attaching to a luggage tag fastener as one means of securing the the imprinted identifier 110 to an item in transit.

In operation, the substrate 110 is attachable to a luggage tag fastener, which is in turn fastened around a luggage handle or other luggage component while checking in with a carrier for transportation. The emblem 114 is readily identifiable by all baggage and cargo handlers in a transportation system. For example, regional carriers may use an emblem showing only local geography, while international carriers may use geographic emblems representing countries or continents. Multiple substrates 110 may also be used. Additionally, there may be a plurality of geographic locations 116 such that a carrier may indicate with a marker or other instrument which geographic location 116 is the termination point of the luggage item. The inventors envision using various colors to indicate geography as well. For example, the display area might be different colors to distinguish airports in a heavily traveled geographic region such as New York City. One having skill in the art would appreciate that the color of the emblem or the color of the display area may also vary depending on the geographic location 116, thus facilitating operation of the current embodiment.

The inventors also envision practicing the invention with a display area showing several geographic regions (not shown). For example, this would allow the imprinted identifier 100 to illustrate a country, a state and a region, allowing this aspect of the invention to operate with airports that are in close proximity. For example, the San Francisco Bay Area has three airports. An imprinted identifier could have a map of California, and also a map of the San Francisco Bay Area showing the differing airports and indicating which airport the luggage should be sent to.

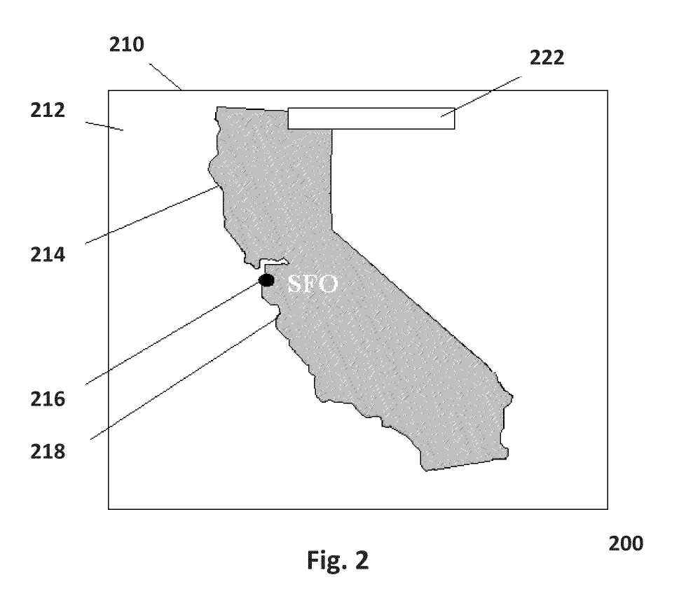

FIG. 2 shows another embodiment according to the current disclosure wherein the imprinted identifier 200 comprises a substrate 210 created from a non-metallic flexible or semi-rigid material such as paper, plastic or cardboard, a display area 212, and an emblem 214 formed to represent a geographical area such as a state, or a country, disposed thereon. The emblem 214 may be any means imprinted or impressed into the display area 212 for providing a visually recognizable image. The emblem 214 is designed to illustrate the location of the destination of the item in transit upon which the imprinted identifier is attached. In the example shown, the emblem 214 particularly indicates the geographic location of San Francisco International airport 216. The substrate 210 provides a slit 222 for attaching airline luggage tag as one means of securing the imprinted identifier to a luggage item.

The inventors envision using various colors to indicate geography as well. For example, the display area might be different colors to distinguish airports in a heavily traveled geographic region such as New York City. One having skill in the art would appreciate that the color of the emblem or the color of the display area may also vary depending on the geographic location 216 thus facilitating operation of the current embodiment.

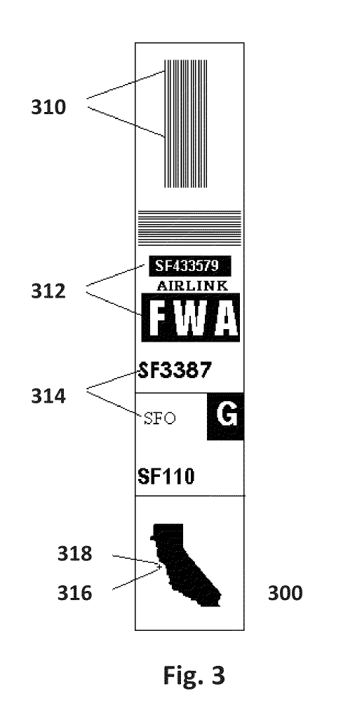

FIG. 3 illustrates an embodiment according to the current disclosure wherein a geographic location is imprinted on an airline luggage tag 300. In the figure, the airline luggage tag 300 has one or more bar codes 310 displayed on the tag 300. The bar codes 310 contain up to four characters signifying the final destination of the luggage item. This embodiment also has airline information 312 and routing information 314, said routing information 314 consisting of one or more flights the luggage item is planned to travel. The final flight is listed first with carrier initials, flight numbers, and date for all parts of the journey to indicate a mini-itinerary.

The present invention provides for an emblem 318 imprinted on the tag 300 such that the emblem 318 displays the geographic location of the terminal point for the luggage item and well as in indication of an airport or city 316. The advantages to this embodiment are that ease of implementation without requiring additional hardware to support the operation. This embodiment may also be practiced using differing colors and emblem representing multiple geographical images to facilitate proper transfer of the luggage item attached thereto.

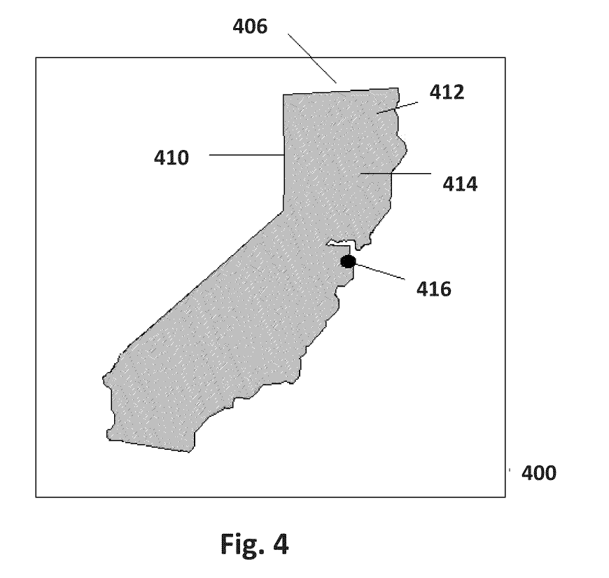

FIG. 4 illustrates yet another embodiment according to the current disclosure wherein the substrate is an adhesive-backed decal 400. In the figure, the present embodiment of an imprinted identifier comprises a substrate 410 created from a non-metallic flexible or semi-rigid material such as paper, plastic or cardboard having a back surface containing an adhesive material such as pressure sensitive adhesive (PSA) (not shown), a display area 412, and an emblem 414 formed to represent a geographical area such as a state or a country disposed thereon. The emblem may be any means imprinted or impressed into the display area 412 for providing a visually recognizable image. In this embodiment the display area 412, substrate 410 and emblem 414 are substantially similar in shape. The emblem 414 is designed to illustrate the location of a termination point of the luggage upon which the imprinted identifier is attached. In the example shown, the emblem 414 particularly indicates the geographic location of San Francisco International Airport 416. The imprinted identifier provides a fastening means by allowing the user to attach it to an item in transit using the PSA.

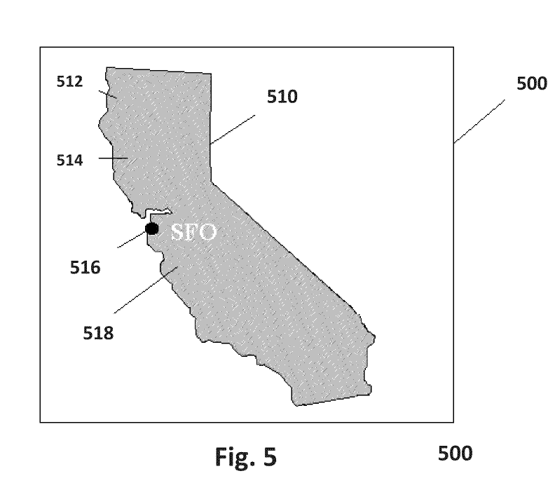

FIG. 5 illustrates yet another embodiment according to the current disclosure with an emblem on a decal 500. In the figure, an imprinted identifier 500, includes a substrate 510 created from a non-metallic flexible or semi-rigid material such as paper, plastic or cardboard having a back surface containing an adhesive material such as PSA (not shown), a display area 512 and an emblem 514 formed to represent a geographical area such as a state or a country disposed thereon. The emblem may be any means imprinted or impressed into the display area 512 for providing a visually recognizable image. The emblem 514 is designed to illustrate the location of a termination point of the luggage upon which the imprinted identifier is attached. In the example shown the emblem 514 particularly indicates the geographic location of San Francisco International Airport 516. The imprinted identifier provides a fastening means allowing the user to apply the imprinted identifier to a luggage item using the PSA. In this embodiment the display area 512 provides room for more information such as airport name and provides for allowing the use of differing colors to contrast the color of the emblem 514 or to provide color coding for differing airports.

FIG. 6 illustrates an embodiment according to the current disclosure wherein a geographic location identifying specific airports 600 in states or countries with airports in multiple cities.

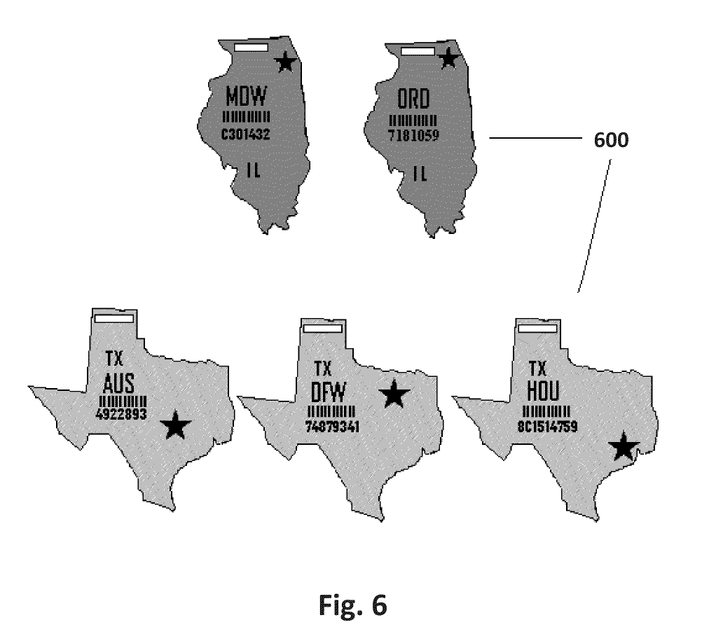

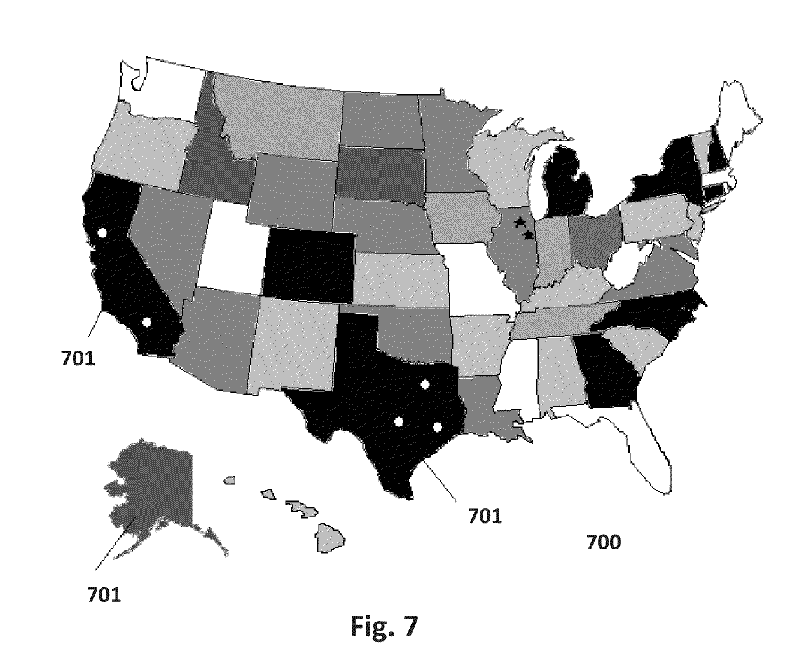

FIG. 7 illustrates an accompanying embodiment according to the current disclosure wherein a color coded map 700 is displayed throughout the transportation hub (airport, cruise ship dock, train terminal, etc.) The individual states 701, or countries, are color coded as well as in the actual shape to assist transportation workers in matching the luggage display and support to assure that items are moved to their appropriate terminal destination.

Exemplary Operating Environments, Components, and Technology FIG. 8 is a block diagram illustrating components of an exemplary operating environment in which various embodiments of the present invention may be implemented. The system 800 can include one or more user computers, computing devices, or processing devices 812, 814, 816, 818, which can be used to operate a client, such as a dedicated application, web browser, etc. The user computers 812, 814, 816, 818 can be general purpose personal computers (including, merely by way of example, personal computers and/or laptop computers running a standard operating system), cell phones or PDAs (running mobile software and being Internet, e-mail, SMS, Blackberry, or other communication protocol enabled), and/or workstation computers running any of a variety of commercially-available UNIX or UNIX-like operating systems (including without limitation, the variety of GNU/Linux operating systems). These user computers 812, 814, 816, 818 may also have any of a variety of applications, including one or more development systems, database client and/or server applications, and Web browser applications. Alternatively, the user computers 812, 814, 816, 818 may be any other electronic device, such as a thin-client computer, Internet-enabled gaming system, and/or personal messaging device, capable of communicating via a network (e.g., the network 810 described below) and/or displaying and navigating Web pages or other types of electronic documents. Although the exemplary system 800 is shown with four user computers, any number of user computers may be supported.

In most embodiments, the system 800 includes some type of network 810. The network may can be any type of network familiar to those skilled in the art that can support data communications using any of a variety of commercially-available protocols, including without limitation TCP/IP, SNA, IPX, AppleTalk, and the like. Merely by way of example, the network 810 can be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, GRPS, GSM, UMTS, EDGE, 2G, 2.5G, 3G, 4G, Wimax, WiFi, CDMA 2000, WCDMA, the Bluetooth protocol known in the art, and/or any other wireless protocol); and/or any combination of these and/or other networks.

The system may also include one or more server computers 802, 804, 806 which can be general purpose computers, specialized server computers (including, merely by way of example, PC servers, UNIX servers, mid-range servers, mainframe computers rack-mounted servers, etc.), server farms, server clusters, or any other appropriate arrangement and/or combination. One or more of the servers (e.g., 806) may be dedicated to running applications, such as a business application, a Web server, application server, etc. Such servers may be used to process requests from user computers 812, 814, 816, 818. The applications can also include any number of applications for controlling access to resources of the servers 802, 804, 806.

The Web server can be running an operating system including any of those discussed above, as well as any commercially-available server operating systems. The Web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 812, 814, 816, 818. As one example, a server may execute one or more Web applications. The Web application may be implemented as one or more scripts or programs written in any programming language, such as Java®, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 812, 814, 816, 818.

The system 800 may also include one or more databases 820. The database(s) 820 may reside in a variety of locations. By way of example, a database 820 may reside on a storage medium local to (and/or resident in) one or more of the computers 802, 804, 806, 812, 814, 816, 818. Alternatively, it may be remote from any or all of the computers 802, 804, 806, 812, 814, 816, 818, and/or in communication (e.g., via the network 810) with one or more of these. In a particular set of embodiments, the database 820 may reside in a storage-area network (“SAN”) familiar to those skilled in the art. Similarly, any necessary files for performing the functions attributed to the computers 802, 804, 806, 812, 814, 816, 818 may be stored locally on the respective computer and/or remotely, as appropriate. In one set of embodiments, the database 820 may be a relational database, such as Oracle 10g, that is adapted to store, update, and retrieve data in response to SQL-formatted commands.

FIG. 9 illustrates an exemplary computer system 900, in which various embodiments of the present invention may be implemented. The system 900 may be used to implement any of the computer systems described above. The computer system 900 is shown comprising hardware elements that may be electrically coupled via a bus 924. The hardware elements may include one or more central processing units (CPUs) 902, one or more input devices 904 (e.g., a mouse, a keyboard, etc.), and one or more output devices 906 (e.g., a display device, a printer, etc.). The computer system 900 may also include one or more storage devices 908. By way of example, the storage device(s) 908 can include devices such as disk drives, optical storage devices, solid-state storage device such as a random access memory (“RAM”) and/or a read-only memory (“ROM”), which can be programmable, flash-updateable and/or the like.

The computer system 900 may additionally include a computer-readable storage media reader 912, a communications system 914 (e.g., a modem, a network card (wireless or wired), an infra-red communication device, etc.), and working memory 99, which may include RAM and ROM devices as described above. In some embodiments, the computer system 900 may also include a processing acceleration unit 916, which can include a digital signal processor DSP, a special-purpose processor, and/or the like.

The computer-readable storage media reader 912 can further be connected to a computer-readable storage medium 910, together (and, optionally, in combination with storage device(s) 908) comprehensively representing remote, local, fixed, and/or removable storage devices plus storage media for temporarily and/or more permanently containing, storing, transmitting, and retrieving computer-readable information. The communications system 914 may permit data to be exchanged with the network and/or any other computer described above with respect to the system 900.

The computer system 900 may also comprise software elements, shown as being currently located within a working memory 918, including an operating system 920 and/or other code 922, such as an application program (which may be a client application, Web browser, mid-tier application, RDBMS, etc.). It should be appreciated that alternate embodiments of a computer system 900 may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, data signals, data transmissions, or any other medium which can be used to store or transmit the desired information and which can be accessed by the computer. Based on the disclosure and teachings provided herein, a person of ordinary skill in the art will appreciate.

The above illustrations provide many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed is:

1. A method for facilitating the movement of an item in transit by facilitating the ability to visually discern, at a glance, whether said item in transit has been incorrectly routed, comprising the following steps in any order:
associating said item in transit with a human-readable emblem that is a graphical representation of said item's final destination and any user-selected indicia;
affixing said emblem and indicia to a substrate to create an imprinted identifier;
associating said emblem with a physical route;
visually inspecting said imprinted identifier attached to said item in transit to determine whether the present route correctly associates with said emblem disposed on said imprinted identifier;
removing an item in transit from the present route with imprinted identifiers showing an emblem that has been determined to be incorrectly associated with the present route;
re-associating said item in transit with imprinted identifier to the correct route and correlating route identifiers;
wherein the user has been trained to visually read and understand the destination of the item in transit by use of said emblems, and moves the item in transit accordingly.

2. The method of claim 1 wherein the final destination of said item in transit is associated with the correlating emblem.

3. The method of claim 1 wherein the correct emblem is disposed onto a substrate to create the imprinted identifier.

4. The method of claim 3 wherein said imprinted identifier to affix to said item in transit is a pre-manufactured multi-use identifier wherein the substrate is substantially the same shape of the emblem.

5. The method of claim 3 wherein said imprinted identifier to affix to said item in transit is a pre-manufactured multi-use identifier wherein the substrate provides usable space outside of the emblem.

6. The method of claim 3 wherein said imprinted identifier to affix to said item in transit is a flexible or semi-rigid material providing a substrate for a custom-printed imprinted identifier.

7. The method of claim 3 wherein said imprinted identifier to affix to said item in transit is an adhesive-backed substrate wherein the substrate is substantially the same shape of the emblem.

8. The method of claim 3 wherein said imprinted identifier to affix to said item in transit is an adhesive-backed substrate wherein the substrate provides usable space outside of the emblem.

9. The method of claim 1 wherein said imprinted identifier is affixed to said item in transit.

10. The method of claim 5 wherein the user attaches said imprinted identifier by one of the methods selected from a group consisting of adhesives, an attached fastener and a space provided specifically to use existing fasteners.

11. The method of claim 1 wherein the visual identification of emblems is facilitated through the use of printed references posted in facilities routing items in transit.

12. The method of claim 1 wherein a misrouted item is identified and re-routed correctly.

13. An apparatus for facilitating the movement of an item in transit comprising:
a non-metallic substrate;
an emblem disposed on the substrate, said emblem being a human-readable graphical representation of the final destination of said item in transit; and
an attachment component to allow a user to view, read and understand the destination of the item in transit by use of said emblems and allowing the user to move the item in transit accordingly.

14. The apparatus of claim 9 wherein said imprinted identifier is a physical printed label comprising at least one of the following:
a pre-manufactured multi-use identifier wherein the substrate is substantially the same shape of the emblem;
a pre-manufactured multi-use identifier wherein the substrate provides usable space outside of the emblem; a flexible or semi-rigid material such as paper, plastic or cardboard providing a substrate for a custom-printed imprinted identifier; and
an adhesive-backed substrate wherein the substrate is substantially the same shape of the emblem; and an adhesive-backed substrate wherein the substrate provides usable space outside of the emblem.

15. The apparatus of claim 9 wherein the display area of the imprinted identifier includes barcodes, additional graphical elements, and textual information.

16. The apparatus of claim 9 wherein the imprinted identifier is physically attached to an item in transit.

17. The apparatus of claim 9 wherein the substrate is a carrier-printed baggage tag having a bar code, and wherein the emblem and any associated indicia are printed on the baggage tag.

18. A system for providing a method of routing identification for an item in transit, the system including a processor operable to execute instructions and a data storage, computer-readable medium for storing the instructions that, when executed by the processor, cause the processor to perform the method comprising:
associating said item in transit with a human-readable emblem that is a graphical representation of said item's final destination and any user-selected indicia;
affixing said emblem and indicia to a substrate to create an imprinted identifier;
associating said emblem with a physical route;
visually inspecting said imprinted identifier attached to said item in transit to determine whether the present route correctly associates with said emblem disposed on said imprinted identifier;
removing an item in transit from the present route with imprinted identifiers showing an emblem that has been determined to be incorrectly associated with the present route;
re-associating said item in transit with imprinted identifier to the correct route and correlating route identifiers wherein said emblems allow a user to more accurately identify the destination of the item in transit, and move the item in transit accordingly.

19. The system of claim 18 for providing a computer method of human-readable item routing identification, the system including a memory containing predetermined instructions and one or more data structures, a processing unit operatively coupled to the memory and capable of executing the predetermined instructions, an output device operatively coupled to the memory and the processing unit, wherein the processing unit executes the predetermined instructions to perform the following steps of:
disposing an emblem and associated indicia onto a given substrate;
associating one or more indicia with one or more final destinations;
accepting as input the final destination of said item in transit;
associating the input to an emblem;
selecting appropriate additional indicia; and
returning data comprising user selected emblem and indicia to a user for printing or modification.

20. A computer readable medium for providing instructions for executing methods of routing identification for an item in transit comprising:
program code for disposing an emblem and associated indicia onto a given substrate;
program code for associating one or more indicia with one or more final destinations;
program code for accepting as input the final destination of said item in transit;
program code for associating the input to an emblem;
program code for selecting appropriate additional indicia; and
program code for returning data comprising user selected emblem and indicia to a user for printing or modification.

21. The computer readable medium of claim, 20, further comprising:
program code for associating said item in transit with a human-readable emblem that is a graphical representation of said item's final destination and any user-selected indicia;
program code for affixing said emblem and indicia to a substrate to create an imprinted identifier;
program code for associating said emblem with a physical route;
program code for visually inspecting said imprinted identifier attached to said item in transit to determine whether the present route correctly associates with said emblem disposed on said imprinted identifier;
program code for visually inspecting said imprinted identifier attached to said item in transit to determine whether the present route correctly associates with said emblem disposed on said imprinted identifier;
program code for removing an item in transit from the present route with imprinted identifiers showing an emblem that has been determined to be incorrectly associated with the present route; and
program code for re-associating said item in transit with imprinted identifier to the correct route and correlating route identifiers wherein said emblems allow a user to more accurately identify the destination of the item in transit, and move the item in transit accordingly.
